(19) United States
(12) Patent Application Publication
(10) Pub. No.: US 2015/0180243 A1
(43) Pub. Date: Jun. 25, 2015

(54) ELECTRONIC DEVICE AND METHOD OF CONTROLLING CHARGING OF ELECTRONIC DEVICE

(71) Applicant: Samsung Electronics Co., Ltd., Suwon-si (KR)

(72) Inventors: Soon-Sang PARK, Daegu (KR); Yong-Gil HAN, Gumi-si (KR); Jang-Hoon LEE, Gumi-si (KR)

(21) Appl. No.: 14/573,547

(22) Filed: Dec. 17, 2014

(30) Foreign Application Priority Data
Dec. 19, 2013 (KR) 10-2013-0159474

(51) Int. Cl. H02J 7/00; H02J 7/02

(52) U.S. Cl. CPC H02J 7/007; H02J 7/025; H02J 7/0047; H02J 2007/0049

(57) ABSTRACT

An electronic device and a method of controlling charging in the electronic device are provided. The electronic device includes a charging current receiver configured to receive a charging current, a voltage and current detector configured to monitor the charging current, and a controller configured to calculate an accumulated amount of charging power according to the monitoring of the charging current and to block battery charging when the accumulated amount of the charging power is greater than or equal to a power amount configured to perform a blocking operation.

### CROSS-REFERENCE TO RELATED APPLICATION(S)

This application claims the benefit under 35 U.S.C. §119(a) of a Korean patent application filed on on Dec. 19, 2013 in the Korean Intellectual Property Office and assigned Serial number 10-2013-0159474, the entire disclosure of which is hereby incorporated by reference.

### TECHNICAL FIELD

The present disclosure relates to a method and an apparatus for charging an electronic device.

### BACKGROUND

Portable electronic devices including mobile phones, smart phones, Personal Digital Assistants (PDAs) and the like may be driven by a rechargeable battery and the battery may be charged by electrical energy from outside sources. The electronic device may receive electrical energy from the outside source to charge the battery in a wired charging scheme or a wireless charging scheme.

For example, one of the wireless charging schemes uses wireless power transmission/reception between an external wireless power providing device and an electronic device. A battery of the electronic device may be charged when the electronic device is put on a chargeable surface without any connection between the electronic device and a separate wire. Such a wireless charging technology includes an electromagnetic induction scheme using a coil, a resonance scheme using resonance, and a Radio Frequency (RF)/microwave radiation scheme converting electrical energy into a microwave and then transmitting the microwave.

Accordingly, provide an electronic device that may receive electrical energy from an outside source through a wire and/or wirelessly in various methods to charge a battery is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device that may receive electrical energy from an outside source through a wire and/or wirelessly in various methods to charge a battery. The electronic device requires a control for the charging when charging the battery. When the charging is fully completed during the charging control, the electronic device requires a control operation to block further charging.

A conventional electronic device measures a voltage of the battery or an intensity of a charging input current and various indexes related to the charging and implements a charging control according to the measured values. Further, when it is difficult to perform a normal charging control only through the indexes, a method is used to block the charging if the charging is continuously performed for a time period. However, such a charging blocking method determines whether the charging is completed only through a charging time regardless of whether the battery is actually fully charged. According to the method, controlling the electronic device is difficult when the charging of the electronic device is discontinuously performed. Further, a problem may occur in which the charging is blocked even in a state where a charged electric charge amount is significantly insufficient since a time period to block the charging arrives.

An electronic device according to various embodiments of the present disclosure may control such that the charging is more accurately blocked by applying a control method suitable for various charging environments and conditions.

In accordance with an aspect of the present disclosure, an electronic device is provided. The electronic device includes a charging current receiver configured to receive a charging current, a voltage and current detector configured to monitor the charging current, and a controller configured to calculate an accumulated amount of charging power according to the monitoring of the charging current and to block battery charging when the accumulated amount of the charging power is greater than or equal to a power amount configured to perform a blocking operation.

In accordance with another aspect of the present disclosure, a method of controlling charging in an electronic device is provided. The method includes receiving a charging current, monitoring the charging current, calculating an accumulated amoutn of charging power according to the monitoring of the charging current, and controlling to block battery charging when the accumulated amount of the charging power is greater than or equal to a power amount configured to perform a blocking operation.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a configuration of an electronic device according to an embodiment of the present disclosure;

FIGS. 2A and 2B are graphs describing a charging blocking operation in a case where a charging current flows into an electronic device according to an embodiment of the present disclosure;

FIG. 3 is a graph describing a charging blocking operation in a case where a charging current corresponding to a low current flows into an electronic device according to an embodiment of the present disclosure;

FIG. 4 is a graph describing a charging blocking operation in a case where a charging current corresponding to a high current flows into an electronic device according to an embodiment of the present disclosure;

FIG. 5 is a flowchart illustrating a method of controlling charging in an electronic device according to a first embodiment of the present disclosure; and

FIG. 6 is a flowchart illustrating a method of controlling charging in an electronic device according to a second embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device according to the present disclosure may be a device which includes a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, a wearable device (for example, a Head-Mounted-Device (HMD) such as electronic glasses, electronic clothes, an electronic bracelet, an electronic necklace, an electronic appcessory, an electronic tattoo, and a smart watch, but is not limited thereto.

According to various embodiments, the electronic device may be a smart home appliance having a communication function. The smart home appliance may include, for example, at least one of television (TV), a Digital Video Disk (DVD) player, an audio device, a refrigerator, an air conditioner, a vacuum cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame, but is not limited thereto.

According to some embodiments, the electronic device may include at least one of various types of medical devices (for example, Magnetic Resonance Angiography (MRA), Magnetic Resonance Imaging (MRI), Computed Tomography (CT), a scanning machine, ultrasonic wave device and the like), a navigation device, a Global Positioning System (GPS) receiver, an Event Data Recorder (EDR), a Flight Data Recorder (FDR), a car infotainment device, ship electronic equipment (for example, navigation equipment for a ship, a gyro compass and the like), avionics, a security device, and an industrial or home robot, but is not limited thereto.

According to various embodiments, the electronic device may include at least one of furniture and/or a part of a building/structure, an electronic board, an electronic signature receiving device, a projector, and various types of measuring devices (for example, a water meter, an electric meter, a gas meter, a radio wave meter and the like). The electronic device according to the present disclosure may be one of the above described various electronic devices or a combination thereof Further, it is apparent to those skilled in the art that the electronic device according to the present disclosure may be applied to any electronic device if the electronic device may charge a battery and the present disclosure is not limited thereto. In addition, any electronic device which may charge a battery may be applied to the present disclosure.

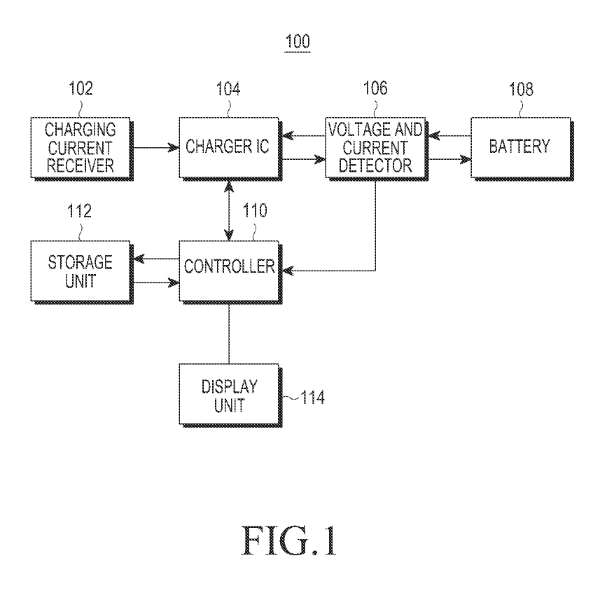

FIG. 1 illustrates a configuration of an electronic device according to an embodiment of the present disclosure.

Referring to FIG. 1, an electronic device 100 according to an embodiment of the present disclosure may include a charging current receiver 102, a charger Integrated Chip (IC) 104, a voltage and current detector 106, a battery 108, a controller 110, a storage unit 112, and a display unit 114, but is not limited thereto.

The controller 110 may control a general operation of the electronic device 100. For example, the controller 110 may control the general operation of the electronic device 100 by using an algorithm, a program, or an application, required for the control, read from the storage unit 112. The controller 110 may be implemented in a form of a Central Processing Unit (CPU), a microprocessor, or a mini computer. According to an embodiment of the present disclosure, the controller 110 may control a charging operation when receiving a charging current from an outside source through a wire or wirelessly. For example, when receiving the charging current, the controller 110 may calculate a power amount by monitoring the charging current and control to block the battery charging according to whether an accumulated amount of the charging power is greater than or equal to a power amount configured to perform a blocking operation. Further, the controller 110 may control such that full charging notification information is displayed on the display unit 114 when the electronic device 100 is fully charged. The controller 110 may control such that the charging of the battery is blocked when a battery voltage is greater than or equal to a full charging voltage. The controller 110 may control the charging of the battery, such that the charging of the battery is blocked when an inflow current flowing into the battery is less than or equal to a cut-off current. The controller 110 may control battery charging such that the charging is terminated according to a charging termination request by the user.

The charging current receiver 102 may receive a charging current through a wire and/or wirelessly. When the charging current is received through the wire, the charging current receiver 102 may receive the charging current from an external power providing device through a contact terminal When the charging current is received wirelessly, the charging current receiver 102 may receive the charging current by using at least one of an electromagnetic induction scheme using a coil, a resonance scheme using resonance, and a Radio Frequency (RF)/microwave radiation scheme converting electrical energy into a microwave and transmitting the microwave.

The charger IC 104 may manage power of the electronic device 100. For example, the charger IC 104 may include a Power Management Integrated Circuit (PMIC). When the charging current is applied, the charger IC 104 may supply power to each component of the electronic device 100 by using the charging current to charge the battery 108. Further, the charger IC 104 may control a charging starting operation and a charging blocking operation according to a control command of the controller 110 or protect a circuit by blocking an input charging current when the charging current greater than or equal to a predetermined reference voltage is input.

The voltage and current detector 106 may detect a current intensity of the charging current supplied to the battery 108 and a voltage of the battery 108. The voltage and current detector 106 may transmit an Analog-Digital Conversion (ADC) value through the charging current intensity to the controller 110.

The storage unit 112 may store a plurality of programs and a plurality of applications for controlling the electronic device 100 or the controller 110 and a program and data for executing various functions. The term “storage unit” includes a Read Only Memory (ROM) (not shown) and a Random Access Memory (RAM) (not shown) within the controller 110, or a memory card (not shown) (for example, a Secure Digital (SD) card or a memory stick) installed in the electronic device 100. The storage unit 112 may include a non-volatile memory, a volatile memory, or a Hard Disk Drive (HDD) or a Solid State Drive (SSD). The storage unit 112 is a machine (for example, computer)-readable medium, and the term of the machine-readable medium may be defined as a medium for providing data to the machine so that the machine performs a specific function. The machine-readable medium may be a storage medium. The storage unit 112 may include a non-volatile medium and a volatile medium. All of these media should be a type that allows the commands transferred by the media to be detected by a physical instrument in which the machine reads the commands into the physical instrument. The machine-readable medium may include at least one of a floppy disk, a flexible disk, a hard disk, a magnetic tape, a magnetic tape, a Compact Disc Read-Only Memory (CD-ROM), an optical disk, a punch card, a paper tape, a Random Access Memory (RAM), a Programmable Read-Only Memory (PROM), an Erasable PROM (EPROM), and a flash-EPROM, but is not limited thereto.

The display unit 114 may be a “touch screen” and provide various graphic user interfaces to the user. For example, the display unit 114 may receive various gesture inputs such as at least one of an approach and a touch through a user's body (for example, a finger including a thumb) or a touchable input unit 114, for example, a pen. The display unit 114 may be implemented in various types, for example, a resistive type, a capacitive type, an infrared type, and an acoustic wave type. The display unit 114 may display full charging notification information under a control of the controller 110 according to an embodiment of the present disclosure. Further, the display unit 114 may display various pieces of information related to a charging control.

According to an embodiment of the present disclosure, when the charging starts, the electronic device 100 configured as described above may block the charging when a time period configured to perform the charging blocking operation arrives as calculated by a timer or block the charging when an accumulated amount of the charging power reaches a power amount configured to block the charging blocking operation.

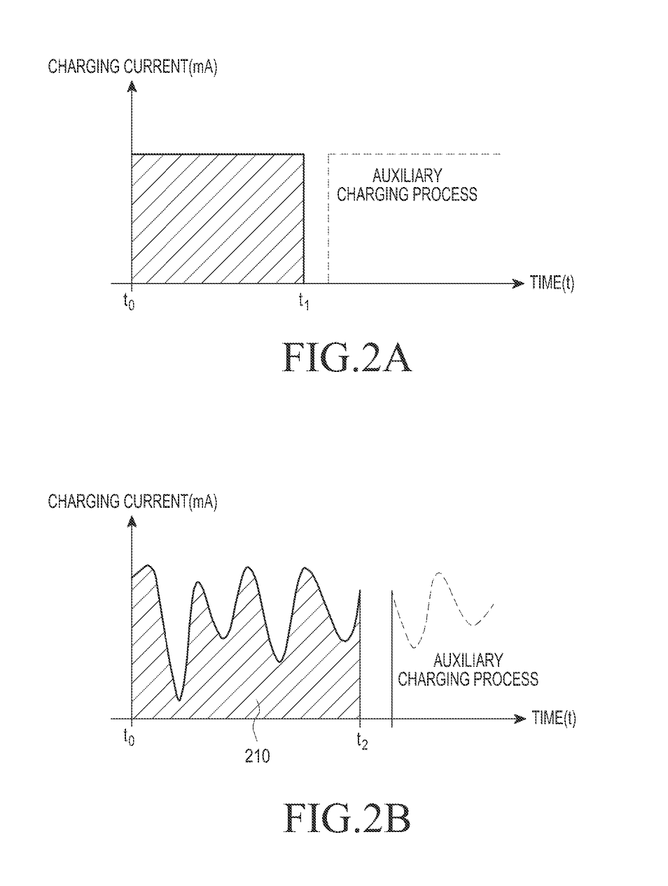

FIGS. 2A and 2B are graphs describing a charging blocking operation of the electronic device according to an embodiment of the present disclosure.

Referring to FIGS. 2A and 2B, FIG. 2A is a graph in a case where the charging is blocked at a time period to block the charging as calculated by a timer and FIG. 2B is a graph in a case where the charging is blocked when an accumulated amount of the charging power reaches a power amount configured to block the charging blocking operation.

Referring to FIG. 2A, the electronic device 100 may start the charging when receiving the charging current and count time through the timer from a charging start time. The electronic device 100 may determine whether a time from the charging start time becomes a charging blocking time t1. The electronic device 100 may control to stop the charging when the charging blocking time t1 arrives. The electronic device 100 may perform an auxiliary charging process after controlling to stop the charging. The auxiliary charging process may refer to a charging process performed to compensate for power lost due to self-discharge or power consumed during use.

At this time, the charging blocking time may be a time period as shown in [Table 1] below according to a capacity of the battery 108.

TABLE 1

| Battery capacity | Charging blocking time |
|---|---|
| Below 1500 mAh | 5 hours |
| Below 1500 mAh~2000 mAh | 6 hours |
| Below 2000 mAh~4500 mAh | 8 hours |
| Below 4500 mAh~7000 mAh | 10 hours |
| 7000 mAh or higher | 10 hours or longer |

Referring to FIG. 2B, the electronic device 100 may start the charging when receiving the charging current and calculate an accumulated amount of the charging power. When the accumulated amount of the charging power reaches a power amount configured to perform the charging blocking operation, the electronic device 100 may block the charging.

For example, the electronic device 100 may calculate an accumulated amount of a charging electric charge 210 by monitoring the charging current from a charging start time t0 and calculate the accumulated amount of the charging power by multiplying the accumulated amount of the charging electric charge and a voltage. The electronic device 100 may control to stop the charging at a time t2 when the accumulated amount of the charging power reaches the power amount configured to perform the charging blocking operation. The electronic device 100 may perform an auxiliary charging process after making the control to stop charging. The auxiliary charging process may refer to a charging process performed to compensate for power lost due to self-discharge or power consumed during use while displaying a full charging state on a screen of the electronic device 100.

However, charging is not terminated and a charging current may be continuously supplied since it is difficult to determine and control a normal charging condition due to an abnormal current outflow or battery defect generation. Further, when a low charging current flows in, even though an amount of charged electric charges is insufficient, the charging may be stopped since a continuous charging blocking time arrives. In addition, even though the charging is completed prior to a charging blocking time due to conditions such as high current inflow, the charging may be continuously performed since a charging completion state is not detected by a factor such as a battery defect.

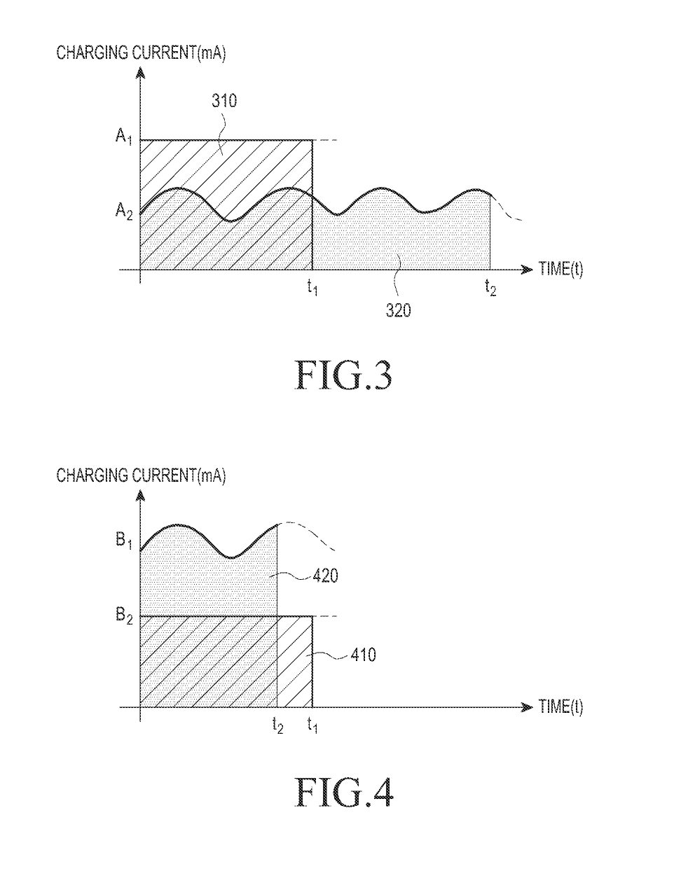

FIG. 3 is a graph describing a charging blocking operation in a case where the charging current corresponding to a low current flows into the electronic device according to an embodiment of the present disclosure.

Referring to FIG. 3, when the charging current corresponding to a low current A2 lower than a charging current A1 is input, an amount of a charging electric charge 310 required for fully charging the battery may not be obtained within the charging blocking time t1. Accordingly, in this case, the charging block time arrives before enough power is given to the battery, so that the charging may stop in a state before the batter is fully charged. Accordingly, in an embodiment of the present disclosure, an accumulated amount of the charging power which may charge an amount of a charging electric charge 320 required for full charging is calculated and thus the charging may be blocked at the time t2 when the accumulated amount of the charging power becomes a power amount configured to block the charging.

FIG. 4 is a graph describing a charging blocking operation in a case where the charging current corresponding to a high current flows into the electronic device according to an embodiment of the present disclosure.

Referring to FIG. 4, when the charging current corresponding to a high current B2 higher than a charging current B1 is input, an amount of a charging electric charge 410 required for the full charging may be charged ahead of the charging blocking time t1. In such a condition, when the charging completion state may not be detected due to factors such as a battery defect, even though the charging has been completed, the charging may not stop since the charging blocking time has not arrived. Accordingly, in an embodiment of the present disclosure, an accumulated amount of the charging power which may charge an amount of a charging electric charge 420 required for the full charging is calculated and thus the charging may be blocked at the time t2 when the accumulated amount of the charging power becomes a power amount configured to block charging.

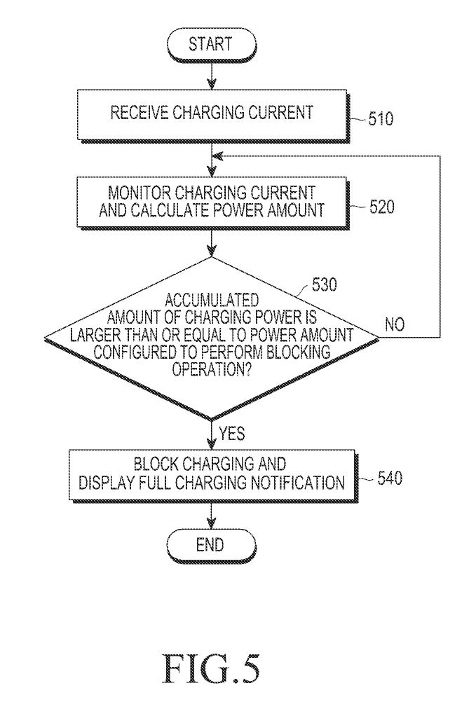

FIG. 5 is a flowchart illustrating a method of controlling the charging in the electronic device according to a first embodiment of the present disclosure.

Referring to FIG. 5, the electronic device 100 may receive a charging current through the charging current receiver 102 in operation 510. For example, the charging current receiver 102 may receive the charging current through a wire or wirelessly.

The electronic device may monitor the charging current and calculate an amount of charging power according to reception of the charging current in operation 520. For example, the electronic device 100 may calculate an accumulated amount of the charging power by multiplying an amount of a charging electric charge by the accumulatively received charging currents for a time period and a voltage.

The electronic device 100 may determine whether the accumulated amount of the charging power corresponds to the power amount configured to perform the charging blocking operation in operation 530. The power amount configured to perform the blocking operation may be an amount of power to become a charging blocking reference. The power amount configured to perform the blocking operation may be determined according to a charging capacity. If the electronic device 100 determines the accumulated amount of the charging power corresponds to the power amount configured to perform the charging blocking operation, proceed to operation 540. Otherwise, return to operation 520.

The electronic device 100 may block the charging in operation 540 when the accumulated amount of the charging power is greater than or equal to the power amount configured to perform the blocking operation. Further, the electronic device 100 may block the charging and then display full charging notification information on the display unit 114.

Accordingly, the battery 108 according to the first embodiment of the present disclosure may not be fully charged when the charging blocking time arrives regardless of the amount of the charging power but is fully charged when the battery is charged with an actual amount of charging power. As a result, more accurate charging may be made.

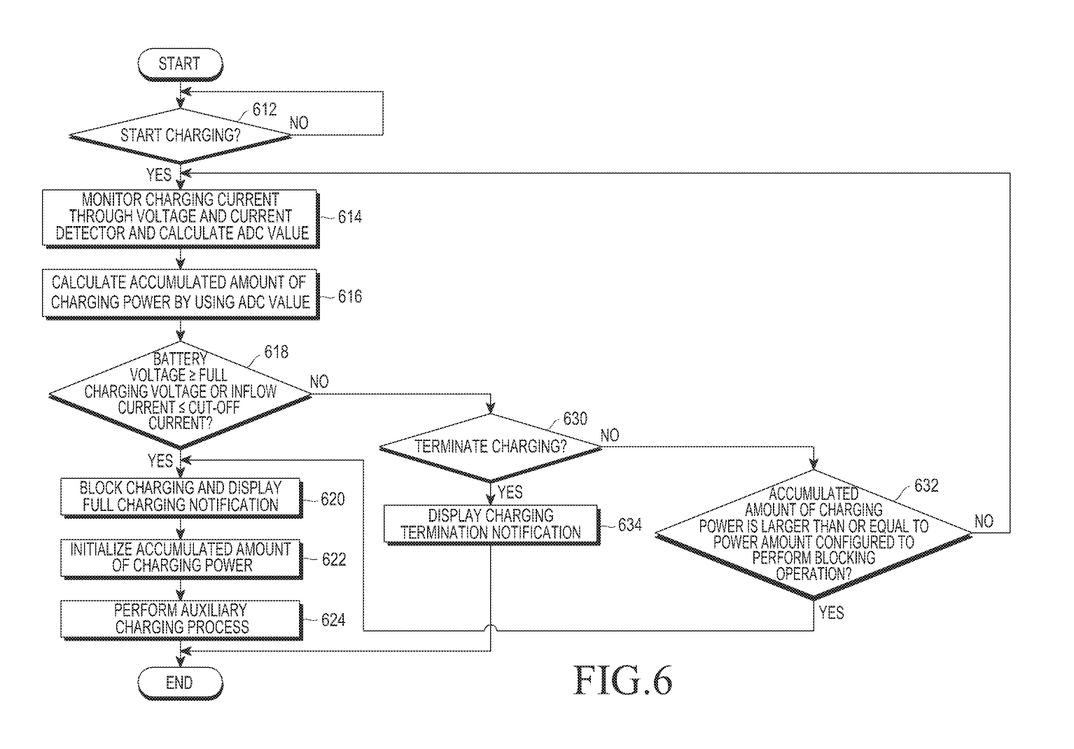

FIG. 6 is a flowchart illustrating a method of controlling the charging in the electronic device according to a second embodiment of the present disclosure.

Referring to FIG. 6, the electronic device 100 may determine whether the charging starts in operation 612. The electronic device 100 may determine whether the charging starts by detecting a charging current received through the charging current receiver 102. When the charging starts, the electronic device 100 may receive the charging current through the charging current receiver 102.

The electronic device 100 may monitor the charging current through the voltage and current detector 106 and calculate an ADC value according to reception of the charging current in operation 614. The electronic device 100 may calculate an accumulated amount of charging power by using the ADC value in operation 616. For example, the electronic device 100 may calculate an accumulated amount of charging power by multiplying an amount of charging electric charge by the accumulatively received charging currents for a time period and a voltage.

The electronic device 100 may determine whether a battery voltage is greater than or equal to a full charging voltage or whether an inflow current is less than or equal to a cut-off current in operation 618. The inflow current may be a current value flowing into the battery 108 and the cut-off current may be a reference current value to determine completion of the charging. When the battery voltage is greater than or equal to the full charging voltage, it may mean that the battery 108 is fully charged. When the inflow current is less than or equal to the cut-off current, it may mean that the battery 108 is fully charged. When the battery voltage is greater than or equal to the full charging voltage or the inflow current is less than or equal to the inflow current, the electronic device 100 may proceed to operation 620.

When the battery voltage is not greater than or equal to the full charging voltage or the inflow current is not less than or equal to the inflow current, the electronic device 100 may determine whether the charging is terminated in operation 630. When there is a charging termination request by the user or the charging current is not input for a long time, the electronic device 100 may determine that the charging is terminated. When the charging is terminated, the electronic device 100 may display charging termination notification information in operation 634.

When the battery voltage is not greater than or equal to the full charging voltage or the inflow current is not less than or equal to the inflow current and the charging is not terminated, the electronic device 100 may determine whether the accumulated amount of the charging power is greater or equal to the power amount configured to perform the blocking operation in operation 632. At this time, the power amount configured to perform the blocking operation may be a power amount to become a charging blocking reference. The power amount configured to perform the blocking operation may be determined according to a charging capacity of the battery 108.

When the accumulated amount of the charging power is not greater than or equal to the power amount configured to perform the blocking operation, the electronic device 100 may return to operation 614. When the accumulated amount of the charging power is greater than or equal to the power amount configured to perform the blocking operation, the electronic device 100 may proceed to operation 620.

The electronic device 100 may block the charging and display full charging notification in operation 620. Further, the electronic device 100 may initialize the accumulated amount of the charging power in operation 622 and perform an auxiliary charging process in operation 624. The auxiliary charging process may refer to a charging process performed to compensate for power lost due to self-discharge or power consumed during use.

According to the various embodiments of the present disclosure as described above, the battery 108 of the electronic device 100 is not fully charged at the charging blocking time regardless of an amount of charging power of the battery 108 but is fully charged when the battery 108 is charged with an actual amount of charging power. As a result, more accurate charging may be made.

Further, according to various embodiments of the present disclosure, when an abnormal current outflow from the electronic device 100 or a low charging current inflow into the electronic device 100 occurs, even though the charging blocking time arrives before the charging is completed, the charging is not blocked and the charging continues until the accumulated amount of charging power becomes the power amount configured to block the charging, so that more accurate full charging may be made.

In addition, according to various embodiments of the present disclosure, the problem may be solved in which the charging may not be stopped since the charging blocking time does not arrive even though the charging is completed, and more accurate full charging may be performed by blocking the charging at the time when the accumulated amount of charging power becomes the power amount configured to block the charging.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a charging current receiver configured to receive a charging current;
a detector configured to monitor the charging current; and
a controller configured to calculate an accumulated amount of charging power according to the monitoring of the charging current and to block battery charging when the accumulated amount of the charging power is greater than or equal to a power amount configured to perform a blocking operation.

2. The electronic device of claim 1, further comprising:
a display unit configured to display full charging notification after the battery charging is blocked.

3. The electronic device of claim 1, wherein the controller performs an auxiliary charging process after the battery charging is blocked.

4. The electronic device of claim 1, wherein the detector monitors the charging current, converts a charging current value to an Analog-Digital Conversion (ADC) value, and provides the ADC value.

5. The electronic device of claim 1, wherein the controller blocks the battery charging when a battery voltage is greater than or equal to a full charging voltage.

6. The electronic device of claim 1, wherein the controller blocks the battery charging when an inflow current flowing into a battery is less than or equal to a cut-off current.

7. The electronic device of claim 1, wherein the controller terminates charging according to a charging termination request by a user.

8. A method of controlling charging in an electronic device, the method comprising:
receiving a charging current;
monitoring the charging current;
calculating an accumulated amount of charging power according to the monitoring of the charging current; and
controlling to block battery charging when the accumulated amount of the charging power is greater than or equal to a power amount configured to perform a blocking operation.

9. The method of claim 8, further comprising:
displaying a full charging notification after the battery charging is blocked.

10. The method of claim 8, further comprising:
performing an auxiliary charging process after the battery charging is blocked.

11. The method of claim 8, wherein the monitoring of the charging current comprises:
monitoring the charging current through a detector;
converting a charging current value to an Analog-Digital Conversion (ADC) value; and
providing the ADC value.

12. The method of claim 8, further comprising:
blocking the battery charging when a battery voltage is greater than or equal to a full charging voltage.

13. The method of claim 8, further comprising:
blocking the battery charging when an inflow current flowing into a battery is less than or equal to a cut-off current.

14. The method of claim 8, wherein the calculating of the accumulated amount of charging power comprises calculating a charging electric charge required for a full charging of a battery.

15. A non-transitory computer-readable storage medium storing instructions that, when executed, cause at least one processor to perform the method of claim 8.
